(19) United States
(12) Patent Application Publication
(10) Pub. No.: US 2026/0146173 A1
(43) Pub. Date: May 28, 2026

(54) THREE-DIMENSIONAL PRINTING WITH COLOR ASSIST AGENT

(71) Applicant: PERIDOT PRINT LLC, Palo Alto, CA (US)

(72) Inventors: Emre Hiro Discekici, San Diego, CA (US); Jake H. Thomas, San Diego, CA (US); Dennis J. Schissler, San Diego, CA (US); Emily Levin, San Diego, CA (US)

(21) Appl. No.: 19/095,558

(22) Filed: Mar. 31, 2025

Related U.S. Application Data
(60) Provisional application No. 63/724,818, filed on Nov. 25, 2024.

(51) Int. Cl. C09D 11/033; B29C 64/165; B33Y 10/00; B33Y 70/00; C08K 3/22; C08K 5/20; C08K 9/02; C08L 3/04

(52) U.S. Cl. CPC C09D 11/033; B29C 64/165; B33Y 10/00; B33Y 70/00; C08K 3/22; C08K 5/20; C08K 9/02; C08L 3/04; B29K 2875/00; C08K 2003/2258

(57) ABSTRACT

A three-dimensional printing kit includes a substantially colorless fusing agent and a color assist agent. The fusing agent includes a liquid vehicle including water, a co-solvent, and an amino acid stabilizer. The fusing agent further includes an infrared (IR) absorbing pigment dispersion including an IR absorbing pigment present in an amount ranging from about 0.01 wt % active to about 1.6 wt % active, based on a total weight of the fusing agent. The color assist agent includes a liquid vehicle including water and a plasticizing co-solvent, and a dye dissolved in the liquid vehicle. Also disclosed is a method of making a colored 3D printed object.

### CROSS-REFERENCE TO RELATED APPLICATION

This application claims the benefit of U.S. Provisional Application Ser. No. 63/724,818, filed Nov. 25, 2024, the content of which is incorporated by reference herein in their entirety.

### BACKGROUND

A three-dimensional (3D) printing process is a form of additive manufacturing that can be used to form 3D solid parts, e.g., using a digital model. Some additive 3D printing techniques involve an iterative application of successive layers of materials, such as build material composition(s), fusing agent(s), and the like. In some of these additive 3D printing techniques, at least partial curing, thermal merging/fusing, melting, sintering, etc. of the build material composition(s) may be used to form the 3D solid parts, and the mechanism for material coalescence may depend upon the type of build material composition(s) used. For some materials, at least partial melting may be accomplished using heat-assisted extrusion. For some other materials, curing or fusing may be accomplished using photonic energy sources, such as ultra-violet light or infrared light sources. 3D printing techniques may be used to generate 3D solid parts with various properties, such as 3D solid parts having color.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features of examples of the present disclosure will become apparent by reference to the following detailed description and drawings.

FIG. 1 is a photograph of a print formed by two-dimensional (2D) printing of an example of a fusing agent and an example of a color assist agent overprinted on the fusing agent.

FIG. 2 is a plot showing the percent (%) strain at break, the tensile strength (MPa), and the Young's Modulus (MPa) of 3D printed objects formed utilizing a Multi-Jet Fusion (MJF) 3D printer with an IR fusing lamp, where 3D printing was accomplished using an example of a fusing agent of the present disclosure, an example of a color assist agent of the present disclosure, and a thermoplastic polyurethane build material.

FIG. 3 is a photograph of two blue-colored, 3D printed objects, both in the form of a shoe sole, which were 3D printed using an MJF 3D printer with an IR fusing lamp, where 3D printing was accomplished using an example of a fusing agent of the present disclosure, an example of a color assist agent of the present disclosure, and a thermoplastic polyurethane build material.

### DETAILED DESCRIPTION

Some 3D printing methods or techniques utilize an energy absorbing substance (e.g., an energy absorber) to pattern a build material composition, thereby forming a patterned region of the build material composition. In these methods or techniques, an entire layer of the build material composition is exposed to radiation, and the patterned region of the build material composition is coalesced and becomes a layer of a 3D solid part (or 3D printed object). As used herein, the term “coalescence” refers to a process where individual droplets and/or particles of material merge together to form a continuous, solid structure. In this context, coalesced material has merged to form a continuous, solid structure. In the patterned region of build material composition, the energy absorbing substance is capable of at least partially penetrating into voids between the particles of the build material composition and is also capable of spreading onto an exterior surface of particles within the build material composition. The energy absorbing substance is also capable of converting absorbed radiation energy into thermal energy, which may be used to coalesce build material particles that have been patterned with the energy absorbing substance. Coalescing causes the build material particles to join or blend to form a single entity (i.e., a layer of the 3D solid part). Coalescing may involve at least partial thermal merging, melting, binding, and/or some other mechanism that causes the build material composition to form the layer of the 3D solid part.

Some 3D printing methods or techniques, such as Multi Jet Fusion (MJF) technology, utilize a fusing agent that includes an infrared (IR) energy absorber to achieve build material coalescence. Such methods or techniques may result in strongly colored 3D solid parts or layer(s) of the 3D solid part, depending, at least in part, on the type and concentration or amount of IR energy absorber used, and possibly other components used in the 3D printing method or technique. For example, some 3D printing methods utilize a high concentrations of darkly-colored IR energy absorbers (e.g., carbon black absorbers), and the darkly-colored energy absorbers may produce darkly-colored objects (e.g., black, dark grey, or other similar dark color). The dark color may be unsuitable for some 3D solid parts, for example, where a predetermined color for the part is white or off-white. While alternatives to darkly-colored energy absorbers have been explored, such alternative IR energy absorbers (low-tint energy absorbers, such as, e.g., cesium tungsten oxide) tend to lack the same performance capabilities of the darkly-colored energy absorbers. For instance, difficulties can be encountered when endeavoring to incorporate a low-tint energy absorber into the fusing agent while maintaining the jettability of the fusing agent (e.g., via thermal inkjet applicators) and the ability of the fusing agent to absorb enough radiation to suitably heat and coalesce the build material particles.

Achieving 3D printed parts with a predetermined color and suitable mechanical properties has also proven challenging. To achieve strong mechanical properties with an IR fusing lamp, a high concentration of IR absorber is often utilized. However, many pigments that absorb IR light also absorb some visible light and result in a colored part. So, while a higher concentration can achieve strong mechanical properties, it can also lead to a colored part. This color, however, is dictated by the radiation absorber, and may not be an intended color.

In light of the foregoing challenges, 3D printing of high mechanical performance, intentionally colored, polymeric (such as elastomeric) parts is not widespread with printers that rely on IR absorbing lamps. As noted, this is due to a lack of solutions in the market that offer both high mechanical performance and a specific cosmetic appearance.

The present disclosure provides a kit for 3D printing and a method of making a colored 3D printed part. The kit and method can be used to generate colored 3D printed parts using current printing technology that employs IR electromagnetic energy source(s) (e.g., IR fusing lamps) to fuse polymeric (e.g., elastomeric) build material particles. It has been found that the colored 3D printed parts can be directly colored during the 3D printing process, even when a build material composition specifically designed for color it not used. A build material composition that is specifically designed for color contains white or off-white polymer particles and a whitener. In the examples set forth herein, this type of build material composition may or may not be used, and when used, will amplify the color saturation and aesthetic quality. As demonstrated in Examples 1-3 below, robust 3D printed parts exhibiting any preselected color from a wide range of colors can be formed using elastomeric materials not specifically designed for color.

The kit and method include/utilize i) a substantially colorless fusing agent that includes a low loading of an IR absorbing pigment and ii) a color assist agent that includes a dye. In one example disclosed herein, the term “substantially colorless” means that a fusing agent containing an absorber having absorbance at 700 nm as its highest absorbing region in the visible spectrum exhibits UV-Vis absorbance <0.053 AU@700 nm. This fusing agent exhibits no color or a low tint of color. In other instances, “substantially colorless” means that the fusing agent imparts a light color that does not or reduces the interfere with the predetermined color that is to achieved using the color assist agent. It is to be understood that the terms “substantially colorless fusing agent” and “fusing agent” are used interchangeably throughout this disclosure. The fusing agent is substantially colorless due, at least in part, to the low loading of the IR absorbing pigment. A “low loading” of the IR absorbing pigment refers to a concentration of 1.6 wt % active or less of the IR absorbing pigment present in the fusing agent. The low loading of the IR absorbing pigment in the fusing agent has been found to sufficiently coalesce the build material particles without substantially imparting color to the 3D printed object or layer being formed. The dye used in the color assist agent, which is applied to the build material particles during printing, imparts a color to the 3D printed object. In this way, any post-processing to color or dye the 3D printed object is not needed.

Further, the presence of the solvent(s) in the color assist agent of the present disclosure helps to modify the thermal properties of the build material such that onset of the melt temperature of the build material is reduced. In particular, the use of plasticizing solvent(s) facilitates a melt temperature reduction of the polymer. This, in turn, facilitates improved fusing between build material layers. As such, use of the color assist agent during printing can thereby improve mechanical properties of the 3D printed past, in addition to enabling a wide variety of colors to be added to the 3D printed part during its fabrication.

In one example, the kit for 3D printing, as disclosed herein, comprises a substantially colorless fusing agent and a color assist agent. The substantially colorless fusing agent includes i) a liquid vehicle including water, a co-solvent, and an amino acid stabilizer and ii) an IR absorbing pigment present in an amount ranging from about 0.01 wt % active to about 1.6 wt % active, based on a total weight of the fusing agent. The color assist agent includes a liquid vehicle including water and a plasticizing co-solvent and ii) a dye dissolved in the liquid vehicle.

Also disclosed herein is a method of making a colored 3D printed part. The method comprises applying a build material composition to form a build material layer, the build material composition comprising polymer particles. The method further comprises based on a 3D object model, selectively applying a substantially colorless fusing agent on at least a portion of the build material layer. The substantially colorless fusing agent includes i) a liquid vehicle including water, a co-solvent, and an amino acid stabilizer and ii) an IR absorbing pigment present in an amount ranging from about 0.01 wt % active to about 1.6 wt % active, based on a total weight of the fusing agent. The method further comprises selectively applying, based on the 3D object model, a color assist agent with at least a portion of the substantially colorless fusing agent to impart a selected color to the build material layer, the color assist agent including i) water and a plasticizing co-solvent and ii) a dye dissolved in the liquid vehicle. The method further includes exposing the build material layer to IR radiation to coalesce the build material composition in the at least the portion and form a layer of the colored 3D printed part.

Also disclosed herein is a 3D printed part formed by the method above, the 3D printed part comprising coalesced polymer particles exhibiting the selected color and containing the IR absorbing pigment intermingled throughout the coalesced polymer particles.

Throughout this disclosure, a weight percentage that is referred to as “wt % active” refers to the loading of an active component of a stock formulation that is present, e.g., in the fusing agent, etc. For example, particles of an energy absorber, such as cesium-doped tungsten oxide nanoparticles, may be present in a water-based formulation (e.g., a stock solution or dispersion) before being incorporated into the fusing agent. In this example, the wt % active of the energy absorber accounts for the loading (as a weight percent) of the energy absorber solids that are present in the 3D fusing agent, and does not account for the weight of the other components (e.g., water, etc.) that are present in the stock solution or dispersion with the energy absorber. The term “wt %,” without the term actives, refers to the loading (e.g., in the fusing agent) of a 100% active component that does not include other non-active components therein.

### Kit for 3D Printing

In an example, the kit for 3D printing includes the fusing agent and the color assist agent. In another example, the kit further includes a polymeric build material composition. In still another example, the kit further includes a detailing agent. Details of the fusing agent, the color assist agent, the detailing agent, and the polymeric build material composition are set forth below.

It should be understood that the fusing agent, color assist agent, and the polymeric build material composition (and the detailing agent, when included) of the kit may be maintained or contained separately until used together in a 3D printing method described in detail below. The fusing agent and/or color assist agent and/or the polymeric build material composition (and/or the detailing agent, when included) may each be contained in a container prior to and during 3D printing, but may be combined together during 3D printing. The containers can be any type of vessel (e.g., reservoir, box, or receptacle) made of any material.

### Fusing Agent

In an example, the substantially colorless fusing agent of the present disclosure includes i) a liquid vehicle including water, a co-solvent, and an amino acid stabilizer and ii) an IR absorbing pigment combined with the liquid vehicle. In another example, the fusing agent includes the liquid vehicle and the IR absorbing pigment, where the liquid vehicle includes water, a co-solvent, an amino acid stabilizer, and, in some instances, an additive. In still another example, the fusing agent consists of the liquid vehicle and the IR absorbing pigment, where the liquid vehicle includes or consists of water, a co-solvent, an amino acid stabilizer and optionally a surfactant. In yet another example, the fusing agent consists of the liquid vehicle and the IR absorbing pigment, where the liquid vehicle consists of water, a co-solvent, an amino acid stabilizer and a surfactant. As will be described herein, in any of these examples, the IR absorbing pigment may initially be part of a dispersion. As such, any example of the fusing agent may also include or consist of the pigment dispersion component(s).

As mentioned, the IR absorbing pigment may be initially present in a dispersion that includes the IR absorbing pigment dispersed in a solvent. In an example, the solvent of the IR absorbing pigment dispersion is water. The IR absorbing pigment dispersion could include, in some instances, an organic co-solvent in addition to water. The IR absorbing pigment dispersion may further include additive(s), such as a surfactant, a humectant, a dispersant, etc. The amount of additive(s) present in the dispersion is small and may even, in some instances, be considered to be negligible, whereas the bulk of the liquid portion of the dispersion is water (alone or in combination with co-solvent(s)). In a particular example, the IR absorbing pigment dispersion includes the IR absorbing pigment, water, and a humectant. In a particular example, the IR absorbing pigment dispersion includes cesium-doped tungsten oxide nanoparticles as the IR absorbing pigment, water, and betaine as the humectant. Examples of the IR absorbing pigment dispersion include about 20 wt % active IR absorbing pigment and a weight ratio of humectant:IR absorbing pigment ranging from about 1:2 to about 2:1.

To form the fusing agent when the IR absorbing pigment is part of the dispersion, the IR absorbing pigment dispersion is mixed with the liquid vehicle. It is to be understood that the liquid components of the IR absorbing pigment dispersion become part of the fusing agent. In an example, the total amount of the IR absorbing pigment dispersion ranges from about 0.1 wt % to about 8 wt %, based on the total weight of the fusing agent. This introduces from about 0.02 wt % active to about 1.6 wt % active of the IR absorbing pigment to the fusing agent. In another example, the total amount of dispersion ranges from about 1 wt % to about 4 wt %, based on the total weight of the fusing agent. This introduces from about 0.02 wt % active to about 0.8 wt % active of the IR absorbing pigment to the fusing agent. It is to be understood that the dispersion may be incorporated into the fusing agent so that the amount of the IR absorbing pigment (e.g., cesium tungsten oxide nanoparticles) that is present in the 3D fusing agent (in terms of wt % active) conforms to any of the suitable ranges set forth herein.

A solid form of the IR absorbing pigment may alternatively be introduced directly into the liquid vehicle of the fusing agent (i.e., without initially being present in a dispersion). To form the fusing agent when the IR absorbing pigment is not part of a dispersion, the solid IR absorbing pigment is mixed with the liquid vehicle. In such instances, the fusing agent includes the IR absorbing pigment dispersed in the liquid vehicle. Such would be the case with a carbon black pigment, which would be incorporated directly into (i.e., directly dispersed in) the liquid vehicle of the fusing agent. In an example, the total amount of IR absorbing pigment ranges from about 0.01 wt % to about 1.6 wt %, based on the total weight of the fusing agent.

The IR absorbing pigment may be selected from any pigment that is capable of absorbing electromagnetic radiation at wavelengths falling within the infrared electromagnetic spectrum (i.e., wavelengths ranging from about 780 nm to about 1 mm). The IR absorbing pigment is thereby considered to be an energy absorber in the examples of the fusing agent described herein. The IR absorbing pigment is selected from the group consisting of a metal oxide and carbon black. In instances where the IR absorbing pigment is a metal oxide, the metal oxide is selected from the group consisting of a tungsten oxide, an iron oxide, a nickel oxide, a copper oxide, a tin oxide, a vanadium oxide, and a cesium oxide. In an example, the method oxide is doped with a metal dopant, such as cesium. In one particular example, the IR absorbing pigment is a cesium-doped tungsten oxide.

The IR absorbing pigment may take the form of particles having a particle size falling within the nanometer range. In an example, the IR absorbing pigment has an average particle size of from greater than 0 nm to less than 220 nm. In another example, the IR absorbing pigment has an average particle size of from greater than 0 nm to 120 nm. In a still another example, the IR absorbing pigment is cesium tungsten oxide nanoparticles and has an average particle size of from about 1 nm to about 25 nm. The IR absorbing pigment, in the form of nanoparticles, may have any suitable particle shape, such as spherical, hexagonal, irregular, flat (e.g., in flake form), etc.

The cesium-doped tungsten oxide IR absorbing pigments may be referred to herein as “cesium-doped tungsten oxide nanoparticles” or simply “cesium tungsten oxide nanoparticles.” In an example, the cesium tungsten oxide nanoparticles have a general formula of CsₓWO₃, where 0<x<1. The cesium tungsten oxide nanoparticles have substantial absorption at wavelengths ranging from about 800 nm to about 4000 nm. As used herein, the term “substantial absorption” means that at least 80% of radiation having wavelengths within the specified range is absorbed by the substance being referred to (e.g., the cesium-doped tungsten oxide). Even at the low loadings/concentrations set forth herein, the cesium tungsten oxide nanoparticles (or other IR absorbing pigments) are capable of absorbing and converting absorbed radiation into a sufficient amount of thermal energy to fuse/coalesce build material particles that have been patterned with the fusing agent (as will be described in more detail in regard to the methods disclosed herein). In this regard, the cesium tungsten oxide nanoparticles, at the low loading/concentration, is a suitable energy absorber for the fusing agent.

The IR absorbing pigment is present in the fusing agent in a low amount. This is due, at least in part, to the presence of the plasticizing solvent used in the fusing agent. The plasticizing solvent, such as benzyl alcohol, reduces the amount of energy required to melt the polymeric component(s) of the build material composition, and thus enables a lower concentration of IR energy absorber to be used in the fusing agent. The energy requirement is reduced through localized reduction in polymer melt temperature (plasticization). A secondary effect is that the replacement of water in the fusing agent with a high boiling point solvent reduces the evaporative cooling effect that water has in the fusing agent. These properties effectively reduce the reliance on absorber concentration to achieve suitable fusing.

Again, a “low amount” or “low loading” or “low concentration” of the IR absorbing pigment means that 1.6 wt % active or less of the IR absorbing pigment is present in the fusing agent, based on a total weight of the fusing agent. In an example, the IR absorbing pigment is present in an amount ranging from about 0.01 wt % active to about 1.6 wt % active, based on the total weight of the fusing agent. In another example, the IR absorbing pigment is present in an amount ranging from about 0.2 wt % active to about 0.8 wt % active, based on the total weight of the fusing agent. In a specific example, cesium tungsten oxide nanoparticles are present in the fusing agent in an amount ranging from about 0.2 wt % active to about 0.6 wt % active, based on the total weight of the fusing agent.

At these low loadings, it is to be understood that carbon black can be used as the IR absorbing pigment. Notably, the fusing agent having a low loading/concentration of carbon black pigment may have a grey tint, but is still considered to be substantially colorless as defined herein as it reduces interference to the final color (when compared to a fusing agent containing carbon black at a higher loading). While use of the low loading of the metal oxide pigment in the fusing agent contributes minimally to the final color of the 3D printed object, use of a low loading of the carbon black pigment would slightly darken the final color of the 3D printed object. In both cases, the pigments suitably function as an absorber of IR radiation energy and enable printing of 3D objects of a preselected color.

The liquid vehicle of the fusing agent includes water, a co-solvent, and an amino acid stabilizer. The co-solvent, which in certain examples may be referred to as a first co-solvent, is a water-soluble or water-miscible co-solvent, examples of which include 2-pyrrolidone, 1-(2-hydroxyethyl)-2-pyrrolidone (HE2P), 2-phenoxyethanol, isopropylidene glycerol, glycerol, 2-methyl-1,3-propanediol, 1,2-butane diol, diethylene glycol, triethylene glycol, tetraethylene glycol, propylene glycol, dipropylene glycol, diethylene glycol butyl ether, other glycol ethers, lactone derivatives, and combinations thereof. In a particular example, the co-solvent is 1-(2-hydroxyethyl)-2-pyrrolidone (HE2P). The co-solvent may be present in the fusing agent in an amount ranging from about 1 wt % active to about 60 wt % active, based on the total weight of the fusing agent. In another example, the co-solvent is present in the fusing agent in an amount ranging from about 5 wt % active to about 50 wt % active, based on the total weight of the fusing agent. In still another example, the co-solvent is present in the fusing agent in an amount ranging from about 5 wt % active to about 20 wt % active, based on the total weight of the fusing agent. In a particular example, about 5 wt % active of 1-(2-hydroxyethyl)-2-pyrrolidone (HE2P) is present in the fusing agent.

In some examples, the fusing agent includes another co-solvent, which can be referred to herein as a second co-solvent. The first and second co-solvents may be combined together to form a solvent package. The first and second co-solvents can be combined together to form the solvent package prior to being combined or mixed with other component(s) of the fusing agent (e.g., IR absorbing pigment or pigment dispersion and other component(s) of the liquid vehicle). Alternatively, each of the first and second co-solvents could be incorporated into the fusing agent separately.

The second co-solvent is a water-soluble or water-miscible organic co-solvent, examples of which include 1-3 butanediol, 1-(2-hydroxyethyl)-2-pyrrolidone, 1,5-pentanediol, 1,2-hexanediol, 2-pyrrolidinone, triethylene glycol, tetraethylene glycol, 2-methyl-1,3-propanediol, 1,6-hexanediol, tripropylene glycol methyl ether, 1,2-propanediol (i.e., propylene glycol), diethylene glycol butyl either, other diols, polyethylene glycol, and combinations thereof. The second solvent may be present in the fusing agent in an amount ranging from about 1 wt % active to about 20 wt % active, based on the total weight of the fusing agent. In another example, the second co-solvent is present in the fusing agent in an amount ranging from about 5 wt % active to about 15 wt % active, based on the total weight of the fusing agent. In a particular example, about 10 wt % active of 1-3 butanediol is present in the fusing agent.

The amino acid stabilizer is used in the fusing agent to aid in preventing agglomeration of the IR absorbing pigment nanoparticles in the liquid vehicle. Examines of the amino acid stabilizer that may be used include beta-alanine, L-histidine, arginine, lysine, and combinations thereof. In a particular example, the amino acid stabilizer is beta-alanine. The amino acid stabilizer may be present in the fusing agent in an amount ranging from about 0.1 wt % active to about 2 wt % active, based on the total weight of the fusing agent. In another example, the amino acid stabilizer is present in the fusing agent in an amount ranging from about 0.5 wt % active to about 1.8 wt % active, based on the total weight of the fusing agent. In a particular example, about 1.5 wt % active of beta-alanine is present in the fusing agent.

The fusing agent may further include additive(s), such as a surfactant, an antimicrobial agent, a chelating agent, an anti-kogation agent, a buffer, and a combination thereof. The total amount of additive(s) present in the fusing agent ranges from about 0.01 wt % active to about 5 wt % active, based on the total weight of the fusing agent. In another example, the total amount of additive(s) present in the fusing agent ranges from about 0.01 wt % active to about 2 wt % active, based on the total weight of the fusing agent. It is to be understood that in any of these examples, “the additive” refers to any of the aforementioned additives, including the combination of the listed additives.

The fusing agent may include a surfactant as the additive. Examples of surfactants that may be used for the fusing agent include non-ionic or anionic surfactants. Some example surfactants include alkyl polyethylene oxides, alkyl phenyl polyethylene oxides, polyethylene oxide block copolymers, acetylenic polyethylene oxides, polyethylene oxide (di) esters, polyethylene oxide amines, dimethicone copolyols, substituted amine oxides, fluorosurfactants, and the like. Some examples of these surfactants include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Yet another anionic surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used, or a combination of surfactants is used, the total amount of surfactant(s) in the fusing agent ranges from about 0.01 wt % active to about 2 wt % active, based on the total weight of the fusing agent. In another example, the total amount of surfactant(s) used ranges from about 0.5 wt % active to about 1.5 wt % active, based on the total weight of the fusing agent. In a particular example, about 0.75 wt % active of a surfactant is present in the fusing agent.

Antimicrobial agents are also known as biocides and/or fungicides. Examples of suitable antimicrobial agents that may be used as an additive include NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant Int. Ltd.), blends of 5-chloro-2-methyl-4-isothiazolin-3-one (CIT or CMIT) and MIT under the tradename KATHON™ (The Dow Chemical Company), and combinations thereof.

In an example, the total amount of antimicrobial agent(s) ranges from about 0.01 wt % active to about 0.05 wt % active, based on the total weight of the fusing agent.

Chelating agents (or sequestering agents) may be included in the liquid vehicle of the fusing agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) may range from greater than 0 wt % active to about 0.5 wt % active, based on the total weight of the fusing agent.

In some examples, the additive is an anti-kogation agent. “Kogation” refers to the deposit of dried printing liquid (e.g., the fusing agent) on a heating element of a thermal inkjet printhead. Anti-kogation agent(s) is/are included to assist in preventing the buildup of kogation. Examples of anti-kogation agents include oleth-3-phosphate (commercially available as CRODAFOS™ 03A or CRODAFOS™ N-3A) or dextran 500,000. Other examples of the anti-kogation agents include CRODAFOST™ HCE (a phosphate-ester from Croda Int.), CRODAFOS® 010A (oleth-10-phosphate from Croda Int.), and DISPERSOGEN® LFH (a polymeric dispersing agent with aromatic anchoring groups, acid form, anionic, from Clariant Int. Ltd.), etc. It is to be understood that any combination of the anti-kogation agents listed may be used.

In an example, the anti-kogation agent is present in the fusing agent in an amount ranging from about 0.01 wt % active to about 2 wt % active, based on the total weight of the fusing agent. In a particular example, about 0.5 wt % active of the anti-kogation agent is present in the fusing agent.

The liquid vehicle may also include a buffer. Examples of suitable buffers include tris(Hydroxymethyl)aminomethane based buffers, such as TRIS and TRIZMA, and (4-(2-hydroxyethyl)-1-piperazineethanesulfonic acid) (HEPES).

In an example, the total amount of buffer(s) may range from 0.01 wt % active to about 1 wt % active, based on the total weight of the fusing agent.

The liquid vehicle of the fusing agent further includes water. The water makes up a balance of the fusing agent, relative to the other components included in the fusing agent (e.g., the IR absorbing pigment and the other liquid vehicle components). The amount of water included in the liquid vehicle depends upon the amount of each of the other components included in the fusing agent. In an example, the amount of water present in the fusing agent ranges from 15 wt % to 92 wt %, based on the total weight of the fusing agent. In another example, the amount of water preset in the fusing agent ranges from 70 wt % to 80 wt %, based on the total weight of the fusing agent. The water may be pure water, deionized water (DI water), distilled water, or any other suitable form of water.

Table 1 below illustrates an example formulation of the fusing agent that may be used in the present disclosure.

TABLE 1

| Component | % active | Wt % |
|---|---|---|
| First Co-Solvent (e.g., HE2P) | 100 | 1-60 |
| Amino Acid Stabilizer (e.g., beta-alanine) | 100 | 1.5 |
| Second Co-Solvent (e.g., 1,3-butanediol) | 100 | 1-20 |
| Anti-Kogation Agent (e.g., CRODAFOS ™ 03A) | 100 | 0.5 |
| Surfactant (e.g., TERGITOL ® 15-S-9) | 100 | 0.75 |
| IR Absorbing Pigment dispersion (e.g., | 20 | 1-4 |
| cesium tungsten oxide dispersion) | | |
| Water | 100 | Balance |

An example formulation of the fusing agent consists of the infrared absorbing pigment; betaine (from the pigment dispersion); a first co-solvent present in an amount ranging from about 5 wt % active to about 50 wt % active, based on the total weight of the fusing agent; a second co-solvent present in an amount ranging from about 2 wt % active to about 20 wt % active, based on the total weight of the fusing agent, the amino acid stabilizer present in an amount ranging from about 0.1 wt % active to about 2 wt % active, based on the total weight of the fusing agent; and an additive selected from the group consisting of a surfactant, an anti-kogation agent, and a combination thereof, wherein the additive is present in an amount ranging from about 0.01 wt % active to about 2 wt % active, based on the total weight of the fusing agent; and a balance of the water.

Any example of the fusing agent set forth herein can be used in a 3D printing method along with the color assist agent, which are applied to a build material composition. The fusing agent and the color assist agent may be used in the 3D printing method with or without a detailing agent. The color assist agent, the detailing agent, and the build material composition are described further below.

### Color Assist Agent

The 3D printing kit further includes a color assist agent. The color assist agent is used to impart color to the 3D printed object and helps modify thermal properties of the build material such that the melt temperature onset is reduced. The latter helps facilitate improved fusing between individual build material layers in a way that other agents of the 3D printing kit are unable to. The leads to 3D printed objects with enhanced mechanical properties (e.g., similar to those formed with high loading carbon black fusing agents). Thus, the color assist agent is multi-faceted in that it enables a variety of colors to be introduced and also contributes generating stronger 3D printed objects. Additionally, the color assist agent may be used to enhance a plasticizing effect from the solvents on the build material particles, which, as described herein, may contribute to the ability to use a lower concentration of the IR absorbing pigment without comprising the fusing efficiency. If the dye in the color assist agent is IR absorbing, it could also enhance fusing efficiency.

The color assist agent includes a liquid vehicle and a colorant. In an example, the color assist agent includes a dye, as the colorant, dissolved in the liquid vehicle. The liquid vehicle may include water and a plasticizing co-solvent. In another example, the color assist agent includes a dye and the liquid vehicle, where the liquid vehicle includes water, a plasticizing co-solvent, and additive(s). In still another example, the color assist agent consists of a dye and the liquid vehicle, where the liquid vehicle includes or consists of water, a plasticizing co-solvent, and optionally a surfactant. In yet another example, the color assist agent consists of a dye and the liquid vehicle, where the liquid vehicle consists of water, a plasticizing co-solvent, and a surfactant.

The dye of the color assist agent can be any water-soluble or solvent-soluble dye. The water-soluble dye or solvent-soluble dye may be selected from a red dye, a yellow dye, a blue dye, a cyan dye, an orange dye, a green dye, a purple dye, a pink dye, and/or the like. Examples of yellow dyes that may suitably be used as the dye include Acid Yellow (AY) dyes, such as AY-17, AY-23, AY-24, AY-42, and AY-73. Examples of red dyes that may suitably be used as the dye include Acid Red (AR) dyes, such as AR-1, AR-18, AR-27, AR-52, AR-73, AR-88, AR-186, and AR 289, as well as Reactive Red (RR) dyes, such as RR-120 and RR-180. Examples of blue dyes that may suitably be used as the dye includes Acid Blue (AB) dyes, such as AB-9, AB-25, AB-93, and Direct Blue (DB) dyes, such as DB-86 and DB-199. While a few examples of the various dyes have been listed, it should be understood that there are many other dyes that can also be included in the color assist agent.

Some examples of the dye are capable of absorbing IR radiation energy. In these examples, the energy exposure intensity and/or duration may be adjusted to account for the additional energy absorption that takes place as a result of the color assist agent. Other examples of the dye in the color assist agent may be visible and/or UV light absorbing, but not IR light absorbing. In these examples, the energy exposure parameters used during the 3D printing process need not be adjusted as additional IR absorption does not take place.

The dye of the color assist agent can be a single dye or a combination of two or more dyes, depending on the color that is to be imparted to the 3D object being printed.

The color assist agent may be prepared by dissolving an effective amount of the dye(s) in the liquid vehicle of the color assist agent to achieve the selected color. In an example, the total amount of dye(s) present in the color assist agent ranges from about 0.1 wt % active to about 10 wt % active, based on a total weight of the color assist agent. In another example, the total amount of dye(s) present in the color assist agent ranges from about 1 wt % active to about 5 wt % active, based on the total weight of the color assist agent. It should be understood that the amount of dye used depends, at least in part, on the depth, intensity, or hue of the predetermined color. For instance, a smaller amount of dye can be used in the color assist agent for lighter colors, whereas a larger amount of dye can be used in the color assist agent for darker colors. For very dark colors, the amount of dye in the color assist agent could exceed 10 wt % active in the color assist agent.

It is to be understood that the number of dyes may be depend upon the selected color. For example, combinations of dyes may be used to achieve a specific color. Coloring mixing techniques may be used to select combinations of dyes.

The liquid vehicle of the color assist agent includes water and a plasticizing co-solvent. The term “plasticizing co-solvent” refers to a non-volatile or lo-volatility solvent that interacts with and increases the flexibility of (i.e., plasticizes) the build material polymer. This may generate a more pliable build material particle surface that improves dye penetration.

The plasticizing co-solvent may be a single plasticizing co-solvent or two or more plasticizing co-solvents. In instances where two or more plasticizing co-solvents are used, the co-solvents may be referred to as a plasticizing solvent package. The plasticizing solvents can be combined together to form the plasticizing solvent package prior to being combined or mixed with other component(s) of the color assist agent (e.g., water, dye, etc.). Alternatively, each of the plasticizing solvents could be incorporated into the color assist agent separately.

In an example, the plasticizing co-solvent is a water-soluble or water-miscible co-solvent such as 1-(2-hydroxyethyl)-2-pyrrolidone, 2-pyrrolidone, 2-phenoxyethanol, isopropylidene glycerol, glycerol, 2-methyl-1,3-propanediol, 1,2-butane diol, diethylene glycol, triethylene glycol, tetraethylene glycol, propylene glycol, dipropylene glycol, diethylene glycol butyl ether, lactone derivatives, polyethylene glycol, isopropyl alcohol, and combinations thereof. In a particular example, the plasticizing co-solvent is 1-(2-hydroxyethyl)-2-pyrrolidone (HE2P). In any of these examples, the amount of plasticizing co-solvent present in the color assist agent ranges from about 10 wt % active to about 60 wt % active, based on the total weight of the color assist agent. Alternatively, the amount of plasticizing co-solvent present in the color assist agent ranges from about 30 wt % active to about 50 wt % active, based on the total weight of the color assist agent. In a particular example, the plasticizing co-solvent is 1-(2-hydroxyethyl)-2-pyrrolidone (HE2P) present in an amount of about 45 wt % active.

In another example, the plasticizing solvent package includes a combination of an aromatic alcohol and a plasticizing solvent that increases the water solubility of the aromatic alcohol. In an example, the aromatic alcohol is benzyl alcohol, which has the formula C₆H₅CH₂OH. Another aromatic alcohol that could be used is 2-phenoxyethanol. The aromatic alcohol is present in the color assist agent in an amount ranging from about 1 wt % active to about 20 wt % active, based on the total weight of the color assist agent. In another example, the aromatic alcohol is present in the color assist agent in an amount ranging from about 5 wt % active to about 15 wt % active, based on the total weight of the color assist agent. In still another example, the aromatic alcohol is present in the fusing agent in an amount ranging from about 8 wt % active to about 12 wt % active, based on the total weight of the color assist agent. It is noted that at concentrations higher than 20 wt % active, the aromatic alcohol could adversely affect print reliability.

In the plasticizing solvent package, the plasticizing solvent is any plasticizing solvent that is a solvent for the aromatic alcohol, and thus will suitably increase the water solubility of the aromatic alcohol. The solvent that is selected may have a higher solubility for the aromatic alcohol than water. In other words, the plasticizing solvent assists in bringing the aromatic alcohol into solution. The inclusion of such a solvent enables the color assist agent to be prepared with a predetermined amount of aromatic alcohol that is suitable for solubilizing and plasticizing the build material during 3D printing.

Plasticizing solvents that are solvents for some aromatic alcohols, such as benzyl alcohol, include 2-pyrrolidone, 1-(2-hydroxyethyl)-2-pyrrolidone (HE2P), glycerol, isopropylidene glycerol (IPG), 2-methyl-1,3-propanediol, 1,2-butane diol, diethylene glycol, triethylene glycol, tetraethylene glycol, dipropylene glycol, diethylene glycol butyl ether, other glycol ethers, poly(ethylene glycol) 300, and combinations thereof.

The amount of solvent for the aromatic alcohol that is included may depend, in part, upon the amount of aromatic alcohol that is included in color assist agent. In an example, the benzyl alcohol and the solvent are present (in the color assist agent) in a weight ratio ranging from about 1:50 to about 2:3. In an example, the benzyl alcohol and the solvent are present in a weight ratio of 1:3.

The plasticizing solvent for the aromatic alcohol (e.g., benzyl alcohol) in the current example of the plasticizing solvent package may be present in the color assist agent in an amount ranging from about 30 wt % active to about 50 wt % active, based on the total weight of the color assist agent. In another example, the plasticizing solvent in the current example of the plasticizing solvent package is present in the color assist agent in an amount ranging from about 40 wt % active to about 50 wt % active, based on the total weight of the color assist agent.

In addition to the plasticizing co-solvent(s) described herein, the color assist agent also includes water and additive(s). These liquid components make up the liquid vehicle of the color assist agent. Examples of the additives include surfactants, antimicrobial agents, chelating agents, anti-kogation agents, buffers, and combinations thereof. Any of the examples of the surfactant, the anti-microbial agent, the chelating agent, the anti-kogation agent, and/or the buffer described herein for the fusing agent can be used, in any of the amounts set forth herein, as an additive(s) for the color assist agent.

The water makes up a balance of the color assist agent, relative to the other components included in the color assist agent (e.g., the plasticizing co-solvent package, the dye(s), and any additives (if present) in the color assist agent). The amount of water included in the color assist agent depends upon the amount of each of the other components included in the color assist agent. In an example, the amount of water present in the color assist agent ranges from 20 wt % to about 90 wt %, based on the total weight of the color assist agent. In another example, the amount of water present in the color assist agent ranges from 25 wt % to 70 wt %, based on the total weight of the fusing agent. The water may be pure water, deionized water (DI water), distilled water, or any other suitable form of water.

In one particular example, the color assist agent consists of: the plasticizing co-solvent present in an amount ranging from about 30 wt % active to about 50 wt % active, based on the total weight of the color assist agent; the aromatic alcohol present in an amount ranging from about 10 wt % active to about 20 wt % active, based on the total weight of the color assist agent; the dye present in an amount ranging from about 0.5 wt % active to about 5 wt % active, based on the total weight of the color assist agent; a surfactant present in an amount ranging from about 0.01 wt % active to about 2 wt % active, based on the total weight of the color assist agent; and the balance is water.

Table 2 below illustrates an example formulation of the color fusing assist agent that may be used:

TABLE 2

| Component | % active | Wt % |
|---|---|---|
| Plasticizing Co-Solvent (e.g., HE2P) | 100 | 30-50 |
| Dye | 100 | 1-5 |
| Aromatic Alcohol (e.g., Benzyl alcohol) | 100 | 1-20 |
| Surfactant (e.g., TERGITOL ® 15-S-9) | 100 | 0.01-1 |
| Water | 100 | Balance |

Another example formulation of the color assist agent consists of the plasticizing co-solvent present in an amount ranging from about 30 wt % active to about 50 wt % active, based on a total weight of the color assist agent; the aromatic alcohol present in an amount ranging from about 10 wt % active to about 20 wt % active, based on the total weight of the color assist agent; the dye present in an amount ranging from about 0.5 wt % active to about 5 wt % active, based on the total weight of the color assist agent; a surfactant present in an amount ranging from about 0.01 wt % active to about 2 wt % active, based on the total weight of the color assist agent; and a balance of water.

Any example of the color assist agent in combination with any example of the fusing agent may be used to generate 3D object layer(s)/object(s) exhibiting a color.

### Detailing Agent

The detailing agent may include a surfactant, a co-solvent, and a balance of water. In an example, the detailing agent consists of these components and no other components. In another example, the detailing agent further includes additional components, such as anti-kogation agent(s), antimicrobial agent(s), and/or chelating agent(s), each of which is described above in reference to the fusing agent. The balance of the detailing agent is water. As such, the amount of water may vary depending upon the amounts of the other components that are included in the detailing agent.

Suitable surfactant(s) for the detailing agent include non-ionic or anionic surfactants. It may be suitable to select a surfactant that does not react with the aromatic alcohol if used in the color assist agent. Some example surfactants include alkyl polyethylene oxides, alkyl phenyl polyethylene oxides, polyethylene oxide block copolymers, acetylenic polyethylene oxides, polyethylene oxide (di) esters, polyethylene oxide amines, dimethicone copolyols, substituted amine oxides, fluorosurfactants, and the like. Some specific examples include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Yet another suitable (anionic) surfactant includes alkyldiphenyloxide disulfonate (e.g., the DOWFAX™ series, such a 2A1, 3B2, 8390, C6L, C10L, and 30599, from The Dow Chemical Company).

The detailing agent may include co-solvent(s). Classes of water soluble or water miscible organic co-solvents that may be used in the detailing agent include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols, 1,3-alcohols, 1,5-alcohols, other diols (e.g., 2-methyl-1,3-propanediol, etc.), ethylene glycol alkyl ethers, propylene glycol alkyl ethers, higher homologs (C6-C12) of polyethylene glycol alkyl ethers, triethylene glycol, tetraethylene glycol, tripropylene glycol methyl ether, N-alkyl caprolactams, unsubstituted caprolactams, 1-methyl-2-pyrrolidone, 2-pyrrolidone, and the like. Other examples of suitable organic co-solvents include dimethyl sulfoxide (DMSO), isopropyl alcohol, ethanol, pentanol, acetone, or the like.

The examples of the detailing agent disclosed herein do not include a colorant. As such, the detailing agent may be colorless. As used herein, “colorless” means that the detailing agent is achromatic and does not include a colorant. The colorless detailing agent, in combination with the fusing agent and the color assist agent, may be used to generate 3D object layer(s)/object(s) exhibiting a color.

### Build Material Composition

The fusing agent and the color assist agent of the present disclosure may be suitable for printing on a polymeric build material composition (referred to interchangeably herein as the “build material composition”). Some examples of suitable polymeric materials for the polymeric build material composition include polyamides, polyacetals, polyolefins, styrene copolymers, acrylic polymers and copolymers, polyethers, polyaryletherketones, polyesters (e.g., a thermoplastic copolyester (TPC)), polycarbonates (PC), a thermoplastic polyurethane elastomer (TPU), a thermoplastic polyolefin elastomer (TPO), a polyether block amide (PEBA), or a combination thereof. In an example, the polymer material is selected from the group consisting of polyethylene, polyethylene terephthalate (PET), polystyrene (PS), polypropylene, high density polyethylene (HDPE), polyoxymethylene (POM), polyether ketone (PEK), polyether ether ketone (PEEK), polyetherketoneketone (PEKK), polyphenylene sulfide (PPS), polytetrafluoroethylene (PTFE), polyvinylidene fluoride (PVDF), acrylonitrile styrene acrylate (ASA), poly(methyl methacrylate) (PMMA), styrene acrylonitrile (SAN), styrene maleic anhydride (SMA), poly(vinyl chloride) (PVC), polyethylenimine (PEI), and combinations thereof. In some instances, the polymeric material may be referred to herein as an elastomer.

In some examples, the polymeric build material composition is a polyamide build material composition including polyamide particles. Examples of suitable polyamides include polyamide-11 (PA 11/nylon 11), polyamide-12 (PA 12/nylon 12), polyamide-6 (PA 6/nylon 6), polyamide-8 (PA 8/nylon 8), polyamide-9 (PA 9/nylon 9), polyamide-66 (PA 66/nylon 66), polyamide-612 (PA 612/nylon 612), polyamide-812 (PA 812/nylon 812), polyamide-912 (PA 912/nylon 912), etc.), a thermoplastic polyamide (TPA), and combinations thereof.

The polymeric material may be made up of similarly sized particles and/or differently sized particles. In an example, the average particle size of the polymeric material ranges from about 2 μm to about 225 μm. In another example, the average particle size of the polymeric material ranges from about 10 μm to about 130 μm. The term “average particle size,” as used herein, refers to a volume-weighted mean diameter of a particle distribution.

In some examples, in addition to the polymeric material, the build material composition may include an antioxidant, an antistatic agent, a flow aid, or a combination thereof. In an example, the build material composition is free of a whitener. It has been found that suitable color fidelity can be achieved using the color assist agent and a build material composition that does not include a whitener. However, it is to be understood that the color assist agent may also be used with a build material composition that does contain a whitener. Whiteners can opacify the build material composition and cover up a tint from the fusing agent, and thus create a whiter canvas upon which the color assist agent is deposited. In other words, the whitener can give the build material composition a higher L* compares to its bulk state with no whitener.

While several examples of the build material composition additives are provided, it is to be understood that these additives are selected to be thermally stable (i.e., will not decompose) at the 3D printing temperatures.

Antioxidant(s) may be added to the build material composition to prevent or slow molecular weight decreases of the polymeric material and/or to prevent or slow discoloration (e.g., yellowing) by preventing or slowing oxidation of the polymeric material. In some examples, the polymeric material may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric material.

In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition in certain examples to bring the L* of the build material composition closer to 100 (white). As mentioned above, pastel colors can be achieved by incorporating the whitener into the build material composition. It is to be understood, however, that some examples of the build material composition do not include the whitener. Examples of suitable whiteners include titanium dioxide (TiO₂), zinc oxide (ZnO), calcium carbonate (CaCO₃), zirconium dioxide (ZrO₂), aluminum oxide (Al2O₃), silicon dioxide (SiO₂), boron nitride (BN), barium sulfate, and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative).

When included, any example of the whitener may be included in the build material composition in an amount ranging from greater than 0 wt % to about 10 wt %, based on the total weight of the build material composition.

Antistatic agent(s) may be added to the polymeric build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.).

In an example, the antistatic agent is added in an amount ranging from greater than 0 wt % to less than 5 wt %, based upon the total weight of the build material composition.

Flow aid(s) may be added to improve the coating flowability of the polymeric build material composition. Flow aids may be particularly beneficial when the polymeric material in the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al2O₃), tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900).

In an example, the flow aid is added in an amount ranging from greater than 0 wt % to less than 5 wt %, based upon the total weight of the build material composition.

### 3D Printing Method

An example of a 3D printing method utilizing the fusing agent and the color assist agent is described in detail below. Prior to execution of the method, it is to be understood that a controller may access data stored in a data store pertaining to a 3D solid part (or 3D printed object) that is to be made/printed. For example, the controller may determine the number of layers of a build material composition that are to be formed, the locations at which the fusing agent and the color assist agent (and the detailing agent) is to be deposited on each of the respective layers, etc.

The method includes applying the polymeric build material composition to form a build material layer; based on a 3D object model, selectively applying a substantially colorless fusing agent onto at least a portion of the build material layer, thereby forming a patterned portion; and based on the 3D object model, selectively applying the color assist agent with at least a portion of the fusing agent to impart a selected color to the build material layer. The fusing agent and the color assist agent used in the method may be any of the respective formulations described above. In another example, the method further includes, based on the 3D object model, applying the detailing agent onto another portion of the build material layer.

In an example method, the build material composition is applied to form a build material layer on a build area platform. It is to be understood that any of the polymeric build materials described herein may be used in the method as the build material composition. A printing system may be used to apply the build material composition. The printing system may include the build area platform, a build material supply containing the build material composition, and a build material distributor.

The build area platform receives the build material composition from the build material supply. The build area platform may be moved in various directions so that the build material composition may be delivered to the build area platform or to a previously formed layer. In an example, when the build material composition is to be delivered, the build area platform may be programmed to advance (e.g., downward or in the Z direction relative to the X-Y plane of the build area platform) enough so that the build material distributor can push the build material composition onto the build area platform to form a substantially uniform layer of the build material composition thereon. The build area platform may also be returned to its original position, for example, when a new part is to be built.

The build material supply may be a container, bed, or other surface that is to position the build material composition between the build material distributor and the build area platform. The build material supply may include heaters so that the build material composition is heated to a supply temperature ranging from about 25° C. to about 200° C. In these examples, the supply temperature may depend, in part, on the build material composition used and/or the 3D printer used. As such, the range provided is one example, and higher or lower temperatures may be used.

The build material distributor may be moved in various directions, over the build material supply and across the build area platform to spread the layer of the build material composition over the build area platform. The build material distributor may also be returned to a position adjacent to the build material supply following the spreading of the build material composition. The build material distributor may be a blade (e.g., a doctor blade), a roller, a combination of a roller and a blade, and/or any other device capable of spreading the build material composition over the build area platform. For instance, the build material distributor may be a counter-rotating roller. In some examples, the build material supply or a portion of the build material supply may translate along with the build material distributor such that build material composition is delivered continuously to the build area platform.

The build material supply may supply the build material composition into a position so that it is ready to be spread onto the build area platform. The build material distributor may spread the supplied build material composition onto the build area platform. The controller may process “control build material supply” data, and in response, control the build material supply to appropriately position the particles of the build material composition, and may process “control spreader” data, and in response, control the build material distributor to spread the build material composition over the build area platform to form the layer.

The build material layer has a substantially uniform thickness across the build area platform. In an example, the build material layer has a thickness ranging from about 50 μm to about 120 μm. In another example, the thickness of the build material layer ranges from about 30 μm to about 300 μm. It is to be understood that thinner or thicker layers may also be used. For example, the thickness of the build material layer may range from about 20 μm to about 500 μm. The layer thickness may be about 2× (i.e., 2 times) the average diameter of the polymeric material at a minimum for finer part definition. In some examples, the layer thickness may be about 1.2× the average diameter of the polymeric material in the build material composition.

After the build material composition has been applied, and prior to further processing, the build material layer may be exposed to heating. In an example, the heating temperature may be below the melting point or melting range of the polymeric material in the build material composition. As examples, the pre-heating temperature may range from about 5° C. to about 50° C. below the melting point or the lowest temperature of the melting range of the polymeric material. In an example, the pre-heating temperature ranges from about 50° C. to about 205° C. In still another example, the pre-heating temperature ranges from about 100° C. to about 190° C. It is to be understood that the pre-heating temperature may depend, in part, on the build material composition used. As such, the ranges provided are some examples, and higher or lower temperatures may be used.

Pre-heating the layer may be accomplished by using any suitable heat source that exposes all of the build material composition in the build material layer to the heat. Examples of the heat source include a thermal heat source (e.g., a heater integrated into the build area platform (which may include sidewalls)) or a radiation source. After the build material layer is formed, and in some instances is pre-heated, the fusing agent is selectively applied on at least a portion of the build material composition in the layer to form a patterned portion.

The amount of the fusing agent that is applied per unit of the build material composition in the patterned portion may be sufficient to absorb and convert enough energy so that the build material composition in the patterned portion will coalesce. The amount of the fusing agent that is applied per unit of the build material composition may depend, at least in part, on the loading of the IR absorbing pigment in the fusing agent, and the polymeric material in the build material composition. In particular, the concentration of the IR absorbing pigment in the fusing agent can be considered. This concentration can be used to determine how much fusing agent to apply to achieve a weight ratio of fusing agent to build material composition for acceptable layer-by-layer fusing. If applying the fusing agent to the build material composition at about a 1:9 weight ratio, then the IR absorbing pigment to build material composition weight ratio (as applied) can be from about 1:900 to about 16:900. If more or less of the fusing agent is applied to the build material composition, then these ratios can be adjusted accordingly. Additionally, if the color assist agent includes an IR absorbing dye, then less of the fusing agent may be applied.

The printing system further includes a first applicator coupled to a first supply, which contains the fusing agent. The fusing agent may be dispensed from the first applicator during printing. The applicator may include a thermal inkjet printhead, a piezoelectric printhead, a continuous inkjet printhead, etc. in fluid communication with the first supply (which is a fluid reservoir/container), and the selective application of the fusing agent may be accomplished by thermal inkjet printing, piezo electric inkjet printing, continuous inkjet printing, etc. The controller may process data, and in response, control the first applicator to deposit the fusing agent onto predetermined portion(s) of the build material composition to generate the patterned portion.

The printing system further includes a second applicator coupled to a second supply, which contains the color assist agent. The color assist agent may be dispensed from the second applicator during printing. Similar to the first applicator, the second applicator may include a thermal inkjet printhead, a piezoelectric printhead, a continuous inkjet printhead, etc. in fluid communication with the second supply (which is also a fluid reservoir/container), and the selective application of the color assist agent may be accomplished by thermal inkjet printing, piezo electric inkjet printing, continuous inkjet printing, etc. The controller may process data, and in response, control the second applicator to deposit the color assist agent with at least a portion of the fusing agent onto predetermined portion(s) of the build material composition to impart a selected color to the build material layer.

In an example, the color assist agent is selectively applied onto the patterned portion(s) of the build material layer; i.e., to the same portion(s) of the build material layer that the fusing agent is applied. For instance, the fusing agent may be applied to the build material composition and then the color assist agent may be applied over the fusing agent. In this respect, the color assist agent may be referred to as an overprint. Alternatively, the fusing agent and the color assist agent may be applied substantially simultaneously onto the same portion(s) of the build material layer. In some instances, the color assist agent may be applied over the same portion(s) of the build material as the fusing agent, as well as onto portion(s) of the build material composition defining a periphery of the 3D printed object/layer to thereby impart more color on the surface of the final 3D printed object. Some portions of the build material layer at the periphery may coalesce during fusing, while other portions of the build material layer at the periphery are cleaned off after printing is complete as colored loose powder.

In some examples, the method further comprises selectively applying, based on the 3D object model, the detailing agent onto another portion of the build material layer outside of the patterned portion. The detailing agent may be selectively applied to the portion(s) of the layer that are not patterned with the fusing agent, and thus that are not to become part of a final 3D object layer. Thermal energy generated during radiation exposure may propagate into the surrounding portion(s) that do not have the fusing agent applied thereto. The propagation of thermal energy may be inhibited and, in turn, the coalescence of the non-patterned build material portion(s) may be prevented when the detailing agent is applied to these other portion(s).

In some other examples, the detailing agent may also or alternatively be applied to the patterned portion or a portion of the patterned portion (i.e., with the fusing agent). The detailing agent may be applied to the patterned portion to provide a cooling effect so that the build material does not overheat and/or to lower the extent of fusing in the area patterned with both the fusing agent and the detailing agent. In these examples, the amount of the detailing agent that is applied should be low enough so that fusing is not completely inhibited. In other examples, the detailing agent and the fusing agent may intermingle at the edge(s) between the patterned portion and the other portion(s).

The detailing agent may be dispensed from a third applicator. The third applicator may include a thermal inkjet printhead, a piezoelectric printhead, a continuous inkjet printhead, etc. in fluid communication with a third supply (which may be a fluid reservoir/container) containing the detailing agent, and the selective application of the detailing agent may be accomplished by thermal inkjet printing, piezo electric inkjet printing, continuous inkjet printing, etc. The controller may process data, and in response, control the third applicator to deposit the detailing agent onto predetermined portion(s) of the build material composition to generate the portion(s).

It is to be understood that the selective application of any of the fusing agent, the color assist agent, and/or the detailing agent may be accomplished in a single printing pass or in multiple printing passes. In some examples, the agent(s) is/are selectively applied in a single printing pass. In some other examples, the agent(s) is/are selectively applied in multiple printing passes. In one of these examples, the number of printing passes used for each of the agents ranges from 2 to 4. Applying the fusing agent, the color assist agent, and/or the detailing agent in multiple printing passes may help to increase the amount which is applied to the build material composition, to avoid liquid splashing, to avoid displacement of the build material composition, etc.

After the fusing agent, the color assist agent, and/or detailing agent are selectively applied in the specific portion(s) of the layer, the entire layer of the build material composition is exposed to electromagnetic radiation. The electromagnetic radiation is emitted from the infrared radiation source. The radiation source may include infrared radiation (IR) lamps, IR emitting diodes, or another broad-spectrum light source emitting IR wavelength(s). The length of time the electromagnetic radiation is applied for, or energy exposure time, may be dependent, for example, on characteristics of the radiation source, characteristics of the build material composition, characteristics of the fusing agent, and/or whether the dye in the color assist agent is infrared absorbing. In an example, a single point of the build material layer is exposed to electromagnetic radiation for a period of time ranging from 0.01 second to 1 second.

It is to be understood that the electromagnetic radiation exposure may be accomplished in a single radiation event or in multiple radiation events. The term “event,” as used herein, refers to one period of exposure of electromagnetic radiation from the radiation source. In an example, a radiation event may occur as a pass of a moveable radiation source over the build material layer (similar to a printing pass). In an example, the exposing of the build material composition is accomplished in multiple radiation events. In a specific example, the number of radiation events ranges from 1 to 8. In still another specific example, the exposure of the build material composition to electromagnetic radiation may be accomplished in 3 radiation events. Exposing the build material composition to electromagnetic radiation in multiple radiation events may help to counteract a cooling effect that may be brought on by the amount of the fusing agent, alone or in combination with the detailing agent that is applied to the build material layer. Additionally, exposing the build material composition to electromagnetic radiation in multiple radiation events may help to sufficiently elevate the temperature of the build material composition in the portion(s) without overheating the build material composition in the non-patterned portion(s).

The fusing agent, and in some instances the dye from the color assist agent, enhance(s) the absorption of the IR radiation, converts the absorbed IR radiation to thermal energy, and promotes the transfer of the thermal heat to the build material composition in contact therewith. In an example, the fusing agent (alone or in combination with the color assist agent) sufficiently elevates the temperature of the build material composition in the portion to a temperature above the melting point or within the melting range of the polymeric material, allowing coalescing/fusing (e.g., thermal merging, melting, binding, etc.) of the build material composition to take place. The application of the electromagnetic radiation forms the 3D object layer.

In some examples, the electromagnetic radiation has a wavelength ranging from 800 nm to 4000 nm. Radiation having wavelengths within the provided ranges may be substantially absorbed (e.g., 80% or more of the applied radiation is absorbed) by the fusing agent and may heat the build material composition in contact therewith. Further, the radiation may not be substantially absorbed (e.g., 25% or less of the applied radiation is absorbed) by the non-patterned build material composition in portion(s).

After the 3D object layer is formed, additional layer(s) may be formed thereon to create an example of the 3D printed object. To form the next layer, additional build material composition may be applied on the layer. The fusing agent is then selectively applied on at least a portion of the additional build material composition, according to the 3D object model. The color assist agent is selectively applied with at least a portion of the fusing agent and, in some instances, on portion(s) of the build material composition defining a periphery of the 3D printed object, also according to the 3D object model. The detailing agent may be applied in any area of the additional build material composition where coalescence is not to take place. After the fusing agent, color assist agent, and/or detailing agent is/are applied, the entire additional layer of the additional build material composition is exposed to electromagnetic radiation in the manner described herein. The application of additional build material composition, the selective applications of the fusing agent and the color assist agent, alone or in combination with the detailing agent, and the electromagnetic radiation exposure may be repeated for a predetermined number of cycles to form the final 3D printed object in accordance with the 3D object model. As such, some examples of the method include repeating the applying of the build material composition, the selectively applying of the fusing agent, the selectively applying of the color assist agent, and the exposing, to form a predetermined number of 3D object layers and a 3D printed object.

In the examples disclosed herein, a 3D object may be printed in any orientation. For example, the 3D object can be printed from bottom to top, top to bottom, on its side, at an angle, or any other orientation. The orientation of the 3D object can also be formed in any orientation relative to the layering of the build material composition. For example, the 3D object can be formed in an inverted orientation or on its side relative to the layering of the build material composition. The orientation of the build within each layer can be selected in advance or even by the user at the time of printing, for example.

Examples of the method described herein may be used to generate individual 3D object layers that make up a three-dimensional (3D) printed object/part. Even though the 3D printed object contains the IR absorbing pigment, the 3D printed object exhibits a color of the dye or a combination of dyes used in the color assist agent. By “exhibits a color,” it is meant that the 3D printed object being referred to closely resembles the color of the dye or the combination of dyes included in the color assist agent.

### 3D Printed Object

The 3D printed object formed by the 3D printing method described above is a colored object and may be referred to as a “colored 3D printed object.” The colored 3D printed object includes coalesced polymeric build material and the IR absorbing pigment intermingled through the coalesced polymer particles. The colored 3D printed object exhibits the selected color. The amount of IR absorbing pigment present in the 3D printed part can be about 10% of the concentration of the IR absorbing pigment in present in the fusing agent. In an example, the IR absorbing pigment is present in the 3D printed part in an amount ranging from about 0.001 wt % to about 0.16 wt %. In another example, the IR absorbing pigment is present in the 3D printed part in an amount ranging from about 0.02 wt % to about 0.08 wt %. In yet another example, the IR absorbing pigment is present in the 3D printed part in an amount ranging from about 0.02 wt % to about 0.06 wt %.

The 3D printed object includes a plurality of build material layers of coalesced polymeric build material. While most of the solvents (e.g., the aromatic alcohol) used in the fusing agent and the color assist agent are evaporated during printing, a residual amount of the solvents is likely to remain. In an example, less than 3 wt % of the solvent(s) remains in the 3D printed object.

It is to be understood that other components of the build material composition (e.g., whitener, etc.), components of the fusing agent, and/or components of the color assist agent that do not evaporate may also be present in the 3D printed object. The weight percentage of each component may depend on the amount used in the build material composition, the fusing agent, and/or the color assist agent, the dimensions of the 3D printed object, the amount of the fusing agent applied, the amount of the color assist agent applied, the evaporation rate (if any) of the components, and other like conditions or parameters.

To further illustrate the present disclosure, examples are given herein. It is to be understood that these examples are provided for illustrative purposes and are not to be construed as limiting the scope of the present disclosure.

### Examples

### Sample Fusing Agent

A sample of a fusing agent having a low loading of a cesium tungsten oxide (“CWO”) dispersion was prepared for use in Examples 1-3. The formulation of the fusing agent is set forth in Table 3 below:

TABLE 3

| Fusing Agent | % active | wt % |
|---|---|---|
| HE2P | 100 | 5 |
| beta-alanine | 100 | 1.5 |
| 1,3-butanediol | 100 | 10 |
| CRODAFOS ® 03A | 100 | 0.5 |
| TERGITOL ® 15-S-9 | 100 | 0.75 |
| CWO Dispersion | 20 | 1-4 |
| DI H2O | 100 | Balance |

### Sample Color Assist Agent

A sample of a color assist agent was prepared for use in Examples 1-3. The color assist agent included a blue dye (a solution including dissolved cyan pigment). The formulation of the color assist agent is set forth in Table 4 below:

TABLE 4

| Color Assist Agent | % active | wt % |
|---|---|---|
| HE2P | 100 | 30-50 |
| Dye | 8-12 | 1-5 |
| Benzyl alcohol | 100 | 14 |
| TERGITOL ® 15-S-9 | 100 | 0.8 |
| DI H2O | 100 | Balance |

### Two-Dimensional Printing Tests

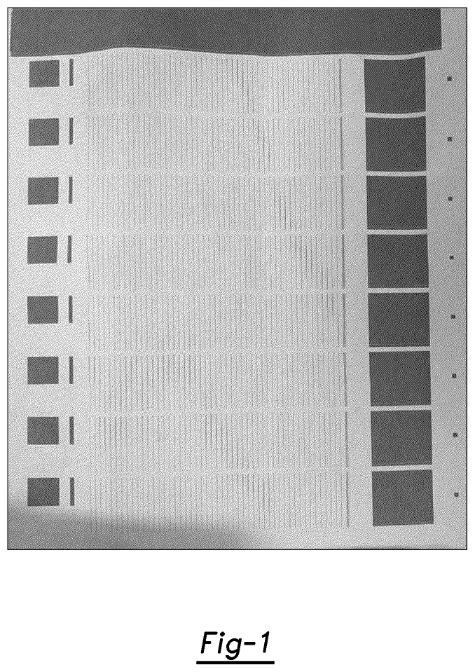

The color assist agent was printed on plain paper using a 2D inkjet printer to generate a 2D test print. A photograph of the 2D test print is shown in FIG. 1. The test print indicated that the color assist agent exhibited good print reliability, in terms of nozzle health. The color assist agent also exhibited a light blue color.

The color assist agent was also tested for decap performance. The term “decap performance,” as referred to herein, means the ability of the agent to readily eject from the printhead, upon prolonged exposure to air. The decap time is measured as the amount of time that a printhead may be left uncapped (i.e., exposed to air) before the printer nozzles no longer fire properly, potentially because of clogging, plugging, or retraction of the IR radiation absorber from the drop forming region of the nozzle/firing chamber. To test the decap performance, a reference line of the color assist agent was printed from a printhead that was not uncapped (i.e., was not exposed to air). Then, the printhead was filled with the color assist agent and left uncapped (i.e., exposed to air) for 9 seconds before the color assist agent was ejected again from the printhead. While the results are not reproduced herein, the decap performance was good at this time.

### Three-Dimensional Printing Tests

Several blue 3D objects in the shape of dogbones were formed utilizing a production-scale, Multi-Jet Fusion (MJF) 3D printer having an IR fusing lamp. The 3D printing was accomplished using the layer-by-layer process described herein using the fusing agent (having the formulation in Table 3), the color assist agent (having the formulation in Table 4), and a thermoplastic polyurethane elastomer as the build material composition. The build material composition did not include a whitener.

Initial 3D printing was performed aiming for 0.1%-1% w/w retention of the CWO nanoparticles in the dogbones. This allowed for maximum color saturation when the color assist agent was applied during 3D printing. The color assist agent was applied at varying densities ranging from 2 to 10 times (2-10×) the density of the fusing agent. It was found that all of the dogbones fused well and did not fall apart when removed from the 3D printer.

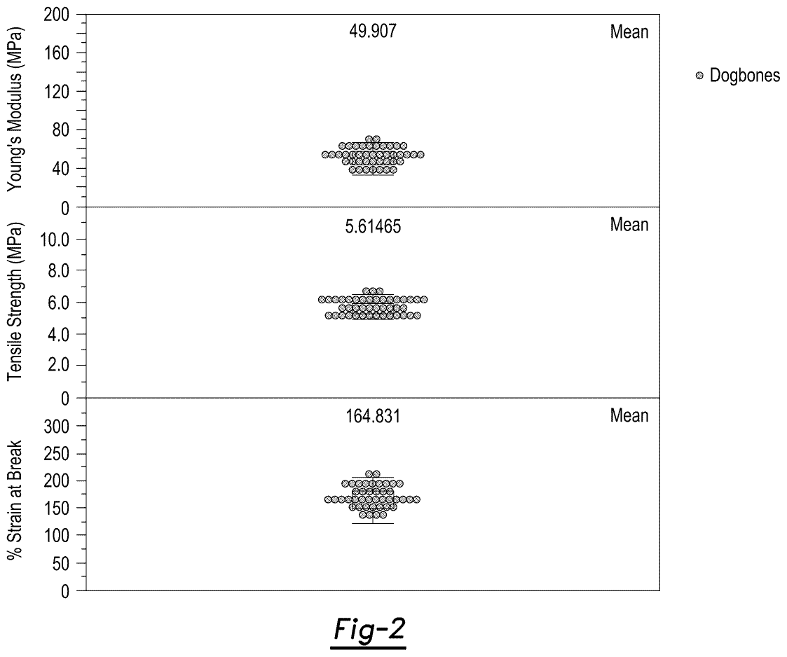

The mechanical properties of the dogbones were then tested. In particular, the percent (%) strain at break, the tensile strength (MPa), and the Young's Modulus (MPa) were measured for each of the dogbones and the results are shown in the plots of FIG. 2. These tests were run in reference to ISO-DIN 53504 optimized for type S2 dog-bones. The following were used: Instrument: Criterion Single Column Frame, Load Cell: 1 kN, Grips: 2 kN, Faces: Serrated, Pneumatic Pressure: 40 psi, Grip spacing: 45 mm, Test Speed: 200 mm/min, and Gauge Length: 25 mm [GL increased due to instrument constraints. Each dogbone is represented by a dot in each of the plots shown in FIG. 2. The results show that all of the dogbones exhibited mechanical properties that are comparable to current standards for thermoplastic polyamide 3D printed objects. Typical targets for such objects include: Tensile Strength: XY 10 MPA and Z 8 MPA, Elongation @ Break: XY 250% and Z 120%, Modulus: XY 65% and Z 75%.

Blue 3D printed shoe soles were also formed utilizing a production-scale, Multi-Jet Fusion (MJF) 3D printer having an IR fusing lamp (the HP Jet Fusion 5200 Series). The 3D printing was accomplished using the layer-by-layer process described herein using the fusing agent (having the formulation in Table 3), the color assist agent (having the formulation in Table 4), and a thermoplastic polyurethane elastomer as the build material composition. The build material composition did not include a whitener.

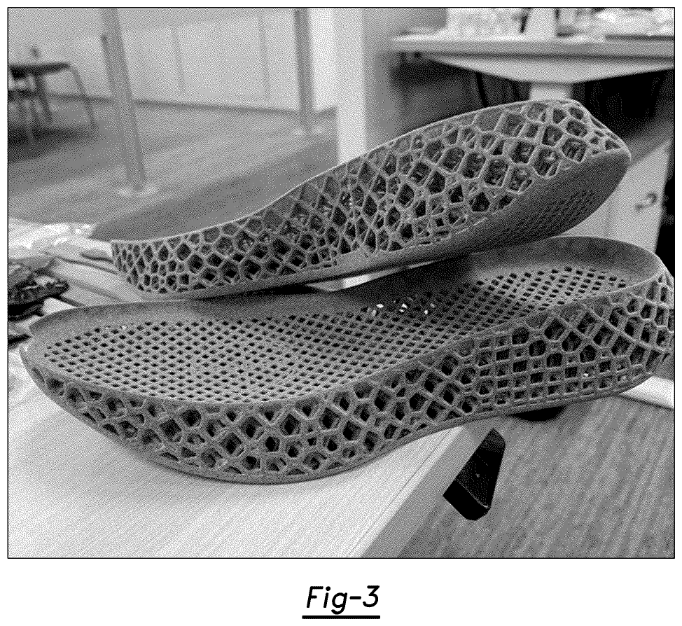

A photograph of the blue-colored shoe soles is shown in FIG. 3. This example demonstrates that the agents and methods set forth herein can formed colored 3D printed elastomeric objects, where coloring takes place during the printing process. As such, post-printing coloring processes are not needed.

### Additional Notes

It is to be understood that the ranges provided herein include the stated range and any value or sub-range within the stated range. For example, from about 0.01 wt % active to about 1.6 wt % active should be interpreted to include not only the explicitly recited limits of from about 0.01 wt % active to about 1.6 wt % active, but also to include individual values, such as about 0.1 wt % active, about 1.2 wt % active, about 1.4 wt % active, etc., and sub-ranges, such as from about 1 wt % active to about 1.5 wt % active, from about 0.25 wt % active to about 1.25 wt % active, from about 0.3 wt % active to about 1.5 wt % active, etc.

Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional printing kit, the kit comprising:
a substantially colorless fusing agent including:
a liquid vehicle including water, a co-solvent, and an amino acid stabilizer; and
an infrared absorbing pigment present in an amount ranging from about 0.01 wt % active to about 1.6 wt % active, based on a total weight of the fusing agent; and
a color assist agent including:
a liquid vehicle including water and a plasticizing co-solvent; and
a dye dissolved in the liquid vehicle.

2. The three-dimensional printing kit as defined in claim 1 wherein the infrared absorbing pigment is selected from the group consisting of a metal oxide and carbon black.

3. The three-dimensional printing kit as defined in claim 2 wherein the infrared absorbing pigment is the metal oxide, and wherein the metal oxide is selected from the group consisting of a tungsten oxide, an iron oxide, a nickel oxide, a copper oxide, a tin oxide, a vanadium oxide, and a cesium oxide.

4. The three-dimensional printing kit as defined in claim 2 wherein infrared absorbing pigment is the metal oxide, and wherein the metal oxide is a cesium-doped tungsten oxide.

5. The three-dimensional printing kit as defined in claim 4 wherein the cesium-doped tungsten oxide is preset in an amount ranging from about 0.2 wt % active to about 0.8 wt % active, based on the total weight of the fusing agent.

6. The three-dimensional printing kit as defined in claim 1 wherein the plasticizing co-solvent of the color assist agent is selected from the group consisting of 1-(2-hydroxyethyl)-2-pyrrolidone, 2-pyrrolidone, 2-phenoxyethanol, isopropylidene glycerol, glycerol, 2-methyl-1,3-propanediol, 1,2-butane diol, diethylene glycol, triethylene glycol, tetraethylene glycol, propylene glycol, dipropylene glycol, diethylene glycol butyl ether, lactone derivatives, polyethylene glycol, isopropyl alcohol, and combinations thereof.

7. The three-dimensional printing kit as defined in claim 1 wherein amino acid stabilizer is selected from the group consisting of beta-alanine, L-histidine, arginine, lysine, and combinations thereof.

8. The three-dimensional printing kit as defined in claim 1 wherein the co-solvent of the fusing agent is a first co-solvent and the fusing agent consists of:
the infrared absorbing pigment dispersion;
betaine;
the first co-solvent present in an amount ranging from about 5 wt % active to about 50 wt % active, based on the total weight of the fusing agent;
a second co-solvent present in an amount ranging from about 2 wt % active to about 20 wt % active, based on the total weight of the fusing agent;
the amino acid stabilizer present in an amount ranging from about 0.1 wt % active to about 2 wt % active, based on the total weight of the fusing agent;
an additive selected from the group consisting of a surfactant, an anti-kogation agent, and a combination thereof, wherein the additive is present in an amount ranging from about 0.01 wt % active to about 2 wt % active, based on the total weight of the fusing agent; and
a balance of the water.

9. The three-dimensional printing kit as defined in claim 1 wherein the liquid vehicle of the color assist agent further includes another co-solvent selected from the group consisting of an aromatic alcohol and propylene glycol, and wherein the aromatic alcohol is selected from the group consisting of benzyl alcohol, 2-phenoxyethanol, and a combination thereof.

10. The three-dimensional printing kit as defined in claim 9 wherein the color assist agent consists of:
the plasticizing co-solvent present in an amount ranging from about 30 wt % active to about 50 wt % active, based on a total weight of the color assist agent;
the aromatic alcohol present in an amount ranging from about 10 wt % active to about 20 wt % active, based on the total weight of the color assist agent;
the dye present in an amount ranging from about 0.5 wt % active to about 5 wt % active, based on the total weight of the color assist agent;
a surfactant present in an amount ranging from about 0.01 wt % active to about 2 wt % active, based on the total weight of the color assist agent; and
the balance is water.

11. The three-dimensional printing kit as defined in claim 1, further comprising a build material composition comprising polymer particles.

12. The three-dimensional printing kit as defined in claim 11 wherein the build material composition is free of a whitener.

13. A method of making a colored three-dimensional printed part, the method comprising:
applying a build material composition to form a build material layer, the build material composition comprising polymer particles;
based on a 3D object model, selectively applying a substantially colorless fusing agent on at least a portion of the build material layer, the fusing agent including:
a liquid vehicle including water, a co-solvent, and an amino acid stabilizer; and
an infrared absorbing pigment present in an amount ranging from about 0.01 wt % active to about 1.6 wt % active, based on a total weight of the fusing agent;
based on the 3D object model, selectively applying a color assist agent with at least a portion of the substantially colorless fusing agent to impart a selected color to the build material layer; the color assist agent including:
a liquid vehicle including water and a plasticizing co-solvent; and
a dye dissolved in the liquid vehicle; and
exposing the build material layer to infrared radiation to coalesce the build material composition in the at least the portion and form a layer of the colored three-dimensional printed part.

14. The method as defined in claim 13, further comprising preparing the color assist agent by dissolving an effective amount of the dye in the liquid vehicle to achieve the selected color.

15. A colored three-dimensional printed part formed by the method of claim 13, the part comprising coalesced polymer particles exhibiting the selected color and containing the infrared absorbing pigment intermingled throughout the coalesced polymer particles.
